(19) United States
(12) Patent Application Publication
(10) Pub. No.: US 2025/0178580 A1
(43) Pub. Date: Jun. 5, 2025

(54) AIR CONTROL VALVE

(71) Applicant: CRRC QIQIHAR ROLLING STOCK CO., LTD., Qiqihar, Heilongjiang (CN)

(72) Inventors: Hua Li, Qiqihar (CN); Yi Xu, Qiqihar (CN); Jia Li, Qiqihar (CN)

(21) Appl. No.: 18/843,873

(22) PCT Filed: Jun. 7, 2023
(86) PCT No.: PCT/CN2023/098995

§ 371 Date: Sep. 4, 2024

(30) Foreign Application Priority Data
May 13, 2022 (CN) 202210521953.7

(51) Int. Cl. B60T 15/02

(52) U.S. Cl. CPC B60T 15/024

(57) ABSTRACT

An air control valve, including a main valve body, a main valve cavity communicates with an auxiliary air cylinder, an air inlet channel communicates with a train pipe, the air inlet channel communicates with the main valve cavity, and an air exhaust channel communicates with the main valve cavity; a sliding valve, which attaches to the main valve cavity, a communicating channel communicates with the air inlet channel, the communicating channel communicates with the air exhaust channel, a brake inflation channel communicates with the main valve cavity, and the brake inflation channel communicates with a brake cylinder; and a shut-off valve, a shut-off valve body is provided with a shut-off valve cavity, a shut-off valve core is disposed in a driving cavity and separates the driving cavity into an auxiliary air cavity and a brake cavity, the auxiliary air cavity communicates with the auxiliary air cylinder, the brake cavity communicates with the brake cylinder, the air exhaust cavity communicates with the air exhaust channel, and the shut-off valve core has an air outlet position for communicating an air inlet of the air exhaust cavity with an air outlet of the air exhaust cavity and a closing position for separating the air inlet of the air exhaust cavity from the air outlet of the air exhaust cavity.

### CROSS-REFERENCE TO RELATED APPLICATIONS

This application is a U.S. national phase patent application of PCT/CN2023/098995 filed Jun. 7, 2023, which claims priority to Chinese Patent Application No. 202210521953.7 filed to the China National Intellectual Property Administration on May 13, 2022 and entitled “Air Control Valve”, the entire contents of each of which are incorporated herein by reference for all purposes.

### TECHNICAL FIELD

The present disclosure relates to the technical field of railway wagons, in particular to an air control valve.

### BACKGROUND

An air control valve, an auxiliary air cylinder, an accelerated relief air cylinder, a brake cylinder and the like form a brake system of a railway wagon. The air control valve is a core control part of the brake system of a vehicle, which controls the brake system of the vehicle to generate braking, relieving and the like. At present, the rail wagons are large in marshalling quantity, the length of a train is large, and the performance requirement on the air control valve is particularly high, which is mainly characterized in that the control valve is required to transmit braking or relieving rapidly, and the synchronization of braking or relieving action of all related control valves in the train is high.

In the relevant art, the air control valve is composed of a main valve, a semi-automatic relief valve, an emergency valve, and an intermediate body. A train pipe realizes the relieving function of the train by inflating the main valve and exhausting the brake cylinder, and the main valve realizes the normal braking function of the train by exhausting air of the train pipe and inflating the brake cylinder. The air control valve rapidly enters a brake position by restricted exhaust of pressure air of the train pipe by the main valve.

However, after the air control valve in the relevant art enters the brake position, there is no device for further assisting the train in exhausting pressure of the train pipe, so that the problem of slow air exhaust of the train in the normal braking process is still outstanding.

### SUMMARY

The present disclosure provides an air control valve, for solving the problem of slow air exhaust of a train in a normal braking process in the relevant art.

The present disclosure provides an air control valve. The air control valve includes: a main valve body, which is provided with a main valve cavity, an air inlet channel and an air exhaust channel, the main valve cavity communicates with an auxiliary air cylinder, an air inlet of the air inlet channel communicates with a train pipe, an air outlet of the air inlet channel communicates with the main valve cavity, and an air inlet of the air exhaust channel communicates with the main valve cavity; a sliding valve, which is movably disposed in the main valve cavity, a side of the sliding valve attaches to a cavity wall of the main valve cavity, the sliding valve is provided with a communicating channel and a brake inflation channel in a penetrating manner, an air inlet of the communicating channel correspondingly communicates with the air outlet of the air inlet channel, an air outlet of the communicating channel correspondingly communicates with the air inlet of the air exhaust channel, an air inlet of the brake inflation channel correspondingly communicates with the main valve cavity, and an air outlet of the brake inflation channel correspondingly communicates with a brake cylinder; and a shut-off valve, which includes a shut-off valve body and a shut-off valve core, the shut-off valve body is provided with a shut-off valve cavity, the shut-off valve cavity includes a driving cavity and an air exhaust cavity which are not communicated, the shut-off valve core is movably disposed in the driving cavity and separates the driving cavity into an auxiliary air cavity and a brake cavity, the auxiliary air cavity communicates with the auxiliary air cylinder, the brake cavity communicates with the brake cylinder, an air inlet of the air exhaust cavity communicates with an air outlet of the air exhaust channel, an air outlet of the air exhaust cavity communicates with an outside, an end of the shut-off valve core extends into the air exhaust cavity, and the shut-off valve core has an air outlet position for communicating the air inlet of the air exhaust cavity with the air outlet of the air exhaust cavity and a closing position for separating the air inlet of the air exhaust cavity from the air outlet of the air exhaust cavity.

Furthermore, the communicating channel includes a first communicating channel and a second communicating channel which are communicated, the second communicating channel is located below the first communicating channel, an air inlet of the first communicating channel correspondingly communicates with the air outlet of the air inlet channel, and an air outlet of the first communicating channel and an air outlet of the second communicating channel correspondingly communicate with the air inlet of the air exhaust channel.

Furthermore, the main valve body and the shut-off valve body are integrally formed, the main valve body and the shut-off valve body form a control valve body together, and the shut-off valve cavity and the main valve cavity are disposed at an interval.

Furthermore, the control valve body is provided with an auxiliary air channel, one end of the auxiliary air channel communicates with the main valve cavity, and another end of the auxiliary air channel communicates with the auxiliary air cavity.

Furthermore, the air control valve further includes a shut-off valve cover, the shut-off valve cover is located on a side of the control valve body and covers the shut-off valve body, the auxiliary air channel includes a first section and a second section which are communicated, the first section is disposed on the shut-off valve cover, and the second section is disposed on the main valve body.

Furthermore, the control valve body is provided with a brake channel, and one end of the brake channel communicates with the brake cavity, and another end of the brake channel communicates with the brake cylinder.

Furthermore, the air control valve further includes a first valve cover, the first valve cover is located at a lower end of the control valve body and covers the main valve body, the brake channel includes a third section and a fourth section which are communicated, the third section is disposed on the first valve cover, and the fourth section is disposed on the shut-off valve body.

Furthermore, the air control valve further includes a piston assembly movably disposed in the main valve cavity, the piston assembly separates the main valve cavity into a first main valve cavity and a second main valve cavity, the first main valve cavity communicates with the train pipe, the air inlet channel and the air exhaust channel both communicate with the second main valve cavity, the piston assembly is provided with a first groove extending in a same direction as the main valve cavity, the side of the sliding valve attaches to the cavity wall of the main valve cavity, and another side of the sliding valve is embedded in the first groove.

Furthermore, a sliding valve sleeve is disposed in the main valve body, an outer side wall of the sliding valve sleeve attaches to the cavity wall of the main valve cavity, the side of the sliding valve attaches to an inner side wall of the sliding valve sleeve, the sliding valve sleeve has an air exhaust hole, a train inflation hole, a brake inflation hole and a communicating hole disposed at intervals, the air outlet of the communicating channel communicates with one end of the air exhaust hole, the air inlet of the air exhaust channel communicates with another end of the air exhaust hole, two ends of the train inflation hole respectively communicate with the air inlet of the air inlet channel and the air inlet of the communicating channel, two ends of the brake inflation hole respectively communicate with the air outlet of the brake inflation channel and the brake cylinder, and two ends of the communicating hole respectively communicate with the auxiliary air cavity and the main valve cavity.

Furthermore, the air control valve further includes a graduating valve, a second groove is disposed on a side wall of the first groove, one side of the graduating valve is embedded in the second groove, another side of the graduating valve attaches to a side wall of the sliding valve, a communicating groove is disposed on a side, facing the sliding valve, of the graduating valve, the communicating channel includes an air inlet section and an air exhaust section which are disposed at an interval, and the communicating groove correspondingly communicates the air inlet section with the air exhaust section.

Furthermore, the main valve body includes a main body and a second valve cover covering the main body, the piston assembly includes a piston body and an elastic film connected with the piston body, a periphery of the elastic film is clamped between the main body and the second valve cover, a space between the elastic film and the second valve cover forms the first main valve cavity, and a space between the elastic film and the main valve body forms the second main valve cavity.

Furthermore, the air control valve further includes an emergency air inflation valve spaced apart from the main valve body, the emergency air inflation valve and the main valve body are integrally formed, the emergency air inflation valve includes an air inflation cavity and a communicating cavity disposed at an interval, an air inlet of the air inflation cavity communicates with the train pipe, an air outlet of the air inflation cavity communicates with the air inlet of the air inlet channel, an air inlet of the communicating cavity communicates with the air inlet of the brake inflation channel, a first air outlet of the communicating cavity communicates with the brake cylinder, and a second air outlet of the communicating cavity communicates with the another end of the brake channel.

By adoption of the technical solution of the present disclosure, after the air control valve enters a brake position, pressure air in the train pipe enters the main valve cavity through the air inlet channel and enters the air exhaust channel through the communicating channel of the sliding valve, so as to be exhausted from the main valve cavity, meanwhile, pressure air in the auxiliary air cylinder enters the brake inflation channel of the sliding valve through the main valve cavity and enters the brake cylinder, after entering the brake position, pressure air in the train pipe is capable of being exhausted through the main valve cavity, meanwhile, pressure air in the auxiliary air cylinder is inflated into the brake cylinder, therefore, in addition to decompression of the train pipe, pressure air in the train pipe is capable of being further exhausted through the main valve cavity, so that the air exhaust speed of the train pipe is accelerated, and the train rapidly enters a braking state.

### BRIEF DESCRIPTION OF THE DRAWINGS

The drawings forming a part of the present disclosure in the specification are adopted to

provide a further understanding to the present disclosure. Schematic embodiments of the present disclosure and descriptions thereof are adopted to explain the present disclosure and not intended to form improper limits to the present disclosure. In the drawings:

FIG. 1 illustrates a principle diagram when an air control valve provided by an embodiment of the present disclosure is at a braking position.

FIG. 2 illustrates a principle diagram when a shut-off valve of an air control valve provided by an embodiment of the present disclosure is at an air outlet position.

FIG. 3 illustrates a principle diagram when a shut-off valve of an air control valve provided by an embodiment of the present disclosure is at a closing position.

FIG. 4 illustrates a partial schematic diagram of a sectional view of an air control valve provided by an embodiment of the present disclosure.

FIG. 5 illustrates a partial schematic diagram of a sectional view of an air control valve provided by an embodiment of the present disclosure.

FIG. 6 illustrates a partial schematic diagram of a sectional view of an air control valve provided by an embodiment of the present disclosure.

FIG. 7 illustrates a partial schematic diagram of a sectional view of an air control valve provided by an embodiment of the present disclosure.

FIG. 8 illustrates a partial schematic diagram of a sectional view of an air control valve provided by an embodiment of the present disclosure.

FIG. 9 illustrates a schematic diagram of an axial side view of a sliding valve in FIG. 8.

FIG. 10 illustrates a schematic diagram of a sectional view of a sliding valve in FIG. 8.

FIG. 11 illustrates a schematic diagram of an axial side view of a sliding valve sleeve in FIG. 8.

FIG. 12 illustrates a partial schematic diagram of a sectional view of an air control valve provided by an embodiment of the present disclosure.

FIG. 13 illustrates a schematic diagram of a front view of an air control valve provided by an embodiment of the present disclosure.

FIG. 14 illustrates a schematic diagram of a top view of an air control valve provided by an embodiment of the present disclosure.

FIG. 15 illustrates a principle diagram when an air control valve provided by an embodiment of the present disclosure is at an air inflation relieving position.

FIG. 16 illustrates a principle diagram when an air control valve provided by an embodiment of the present disclosure is at a local decompression position.

FIG. 17 illustrates a principle diagram when an air control valve provided by an embodiment of the present disclosure is at a brake pressure maintaining position.

FIG. 18 illustrates a schematic diagram of a sectional view of an air control valve provided by an embodiment of the present disclosure.

The drawings include the following reference signs.

10. Main valve body; 11. Main valve cavity; 111. First main valve cavity; 112. Second main valve cavity; 12. Air inlet channel; 13. Air exhaust channel; 14. Sliding valve sleeve; 141. Air exhaust hole; 142. Train inflation hole; 143. Brake inflation hole; 144. Communicating hole; 15. Main body; 16. Second valve cover; 20. Sliding valve; 21. Communicating channel; 211. First communicating channel; 212. Second communicating channel; 213. Air inlet section; 214. Air exhaust section; 22. Brake inflation channel;

30. Shut-off valve; 31. Shut-off valve body; 311. Shut-off valve cavity; 312. Driving cavity; 3121. Auxiliary air cavity; 3122. Brake cavity; 313. Air exhaust cavity; 32. Shut-off valve core; 40. Control valve body; 41. Auxiliary air channel; 411. First section; 412. Second section; 42. Brake channel; 421. Third section; 422. Fourth section; 51. Shut-off valve cover; 52. First valve cover; 60. Piston assembly; 61. First groove; 62. Second groove; 63. Piston body; 64. Elastic film; 70. Graduating valve; 71. Communicating groove; 80. Emergency air inflation valve; 81. Air inflation cavity; 82. Communicating cavity; 100. Auxiliary air cylinder; 110. Train pipe; and 120. Brake cylinder.

### DETAILED DESCRIPTION OF THE EMBODIMENTS

The technical solutions in the embodiments of the present disclosure will be clearly and completely described below in combination with the drawings in the embodiments of the present disclosure. It is apparent that the described embodiments are not all embodiments but part of embodiments of the present disclosure. The following description for at least one exemplary embodiment is merely illustrative in nature and is in no way intended to limit the present disclosure, its application, or uses. All other embodiments obtained by those of ordinary skill in the art based on the embodiments of the present disclosure without creative efforts shall fall within the protection scope of the present disclosure.

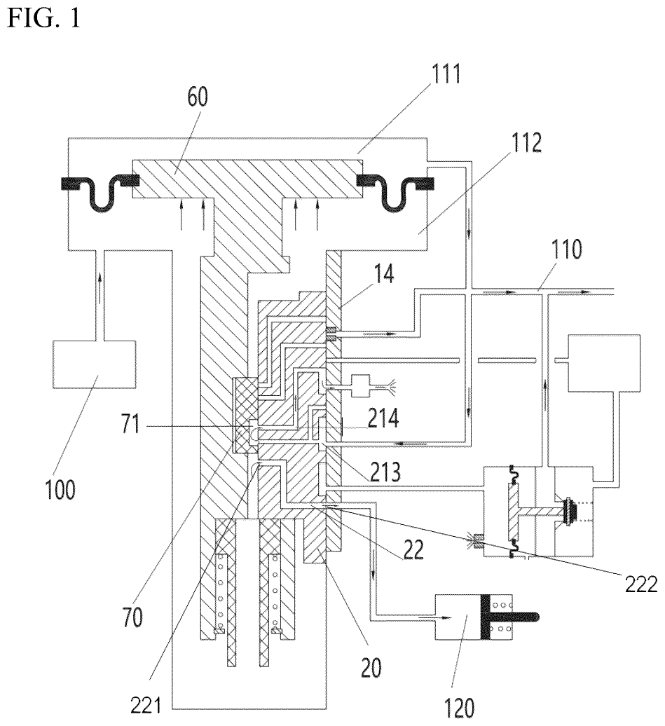

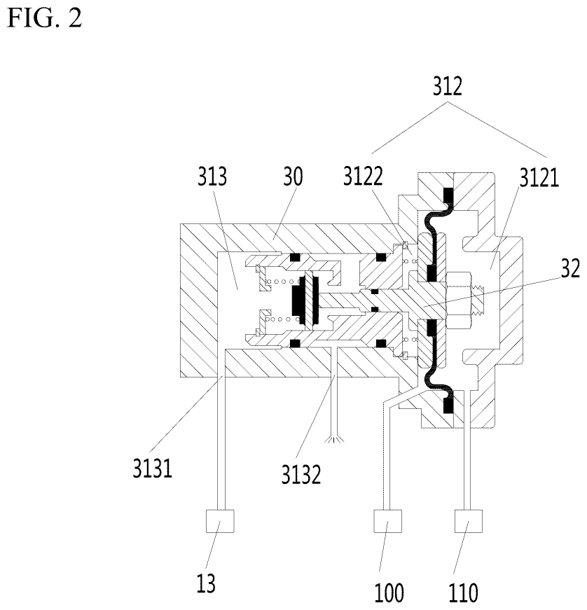

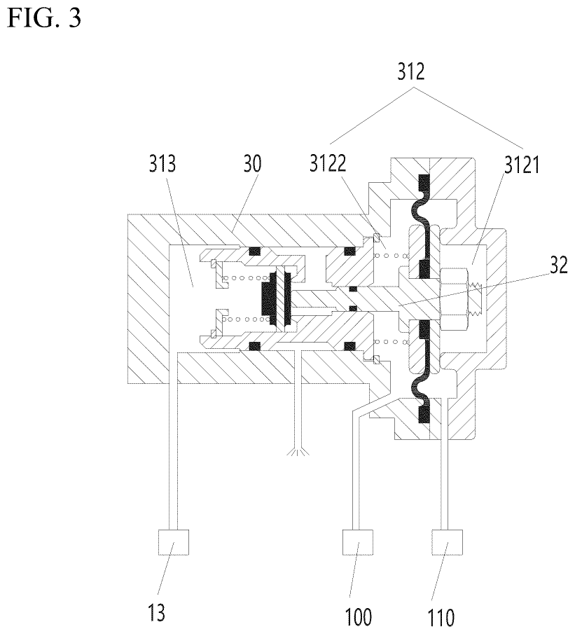

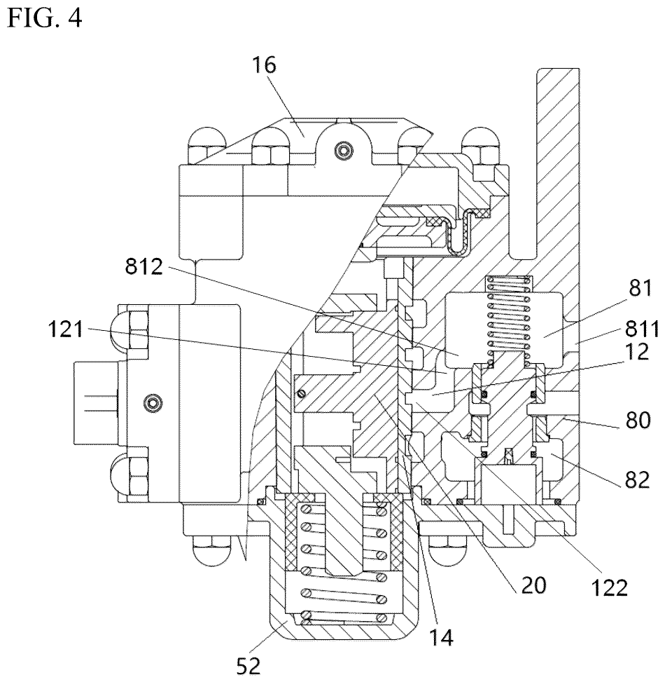

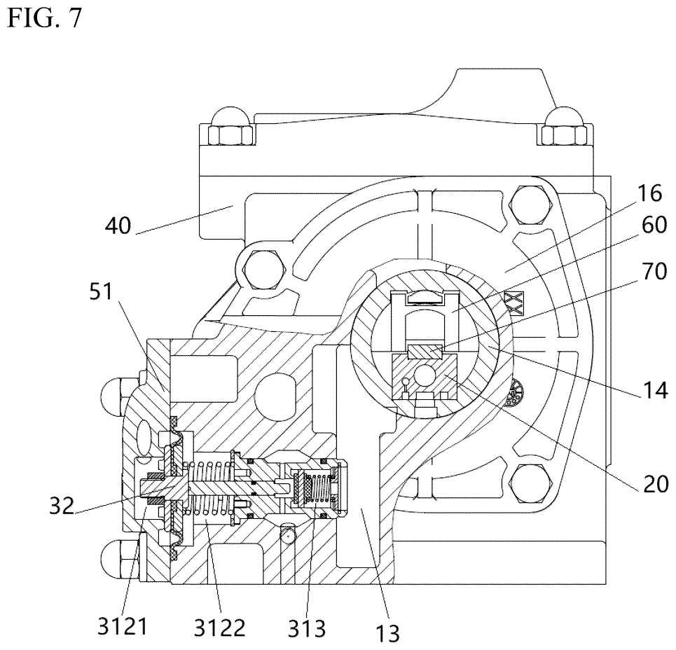

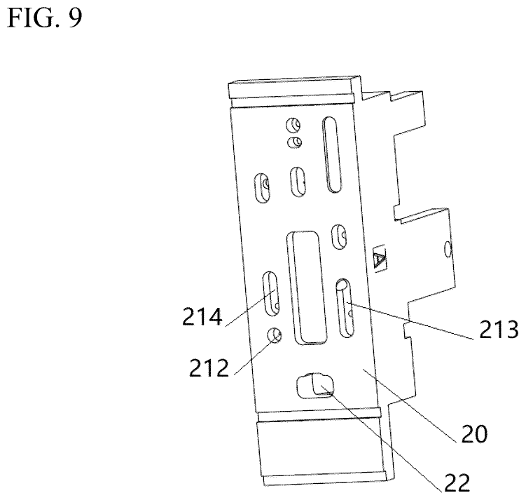

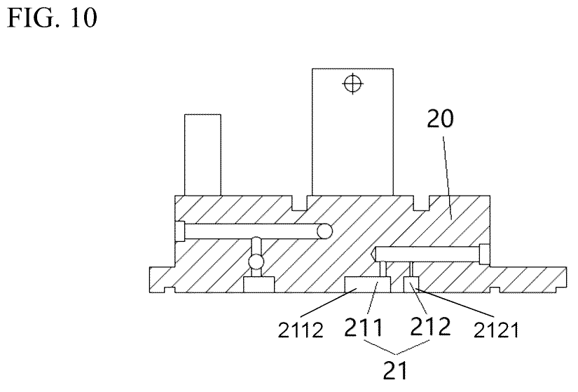

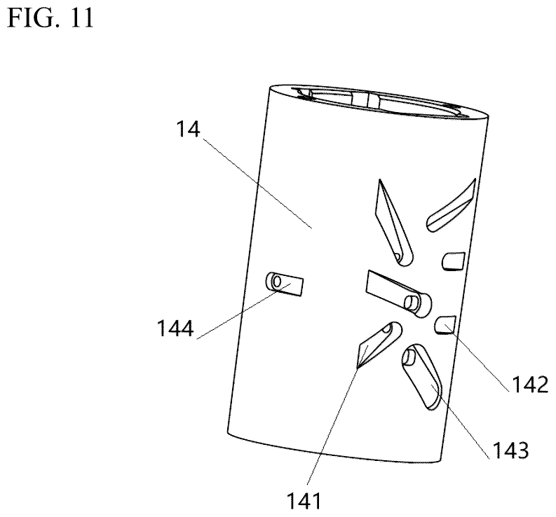

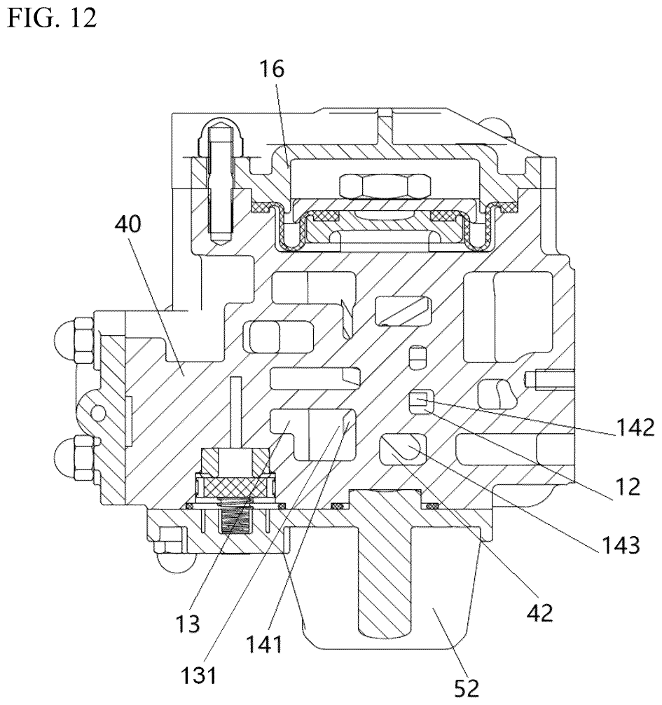

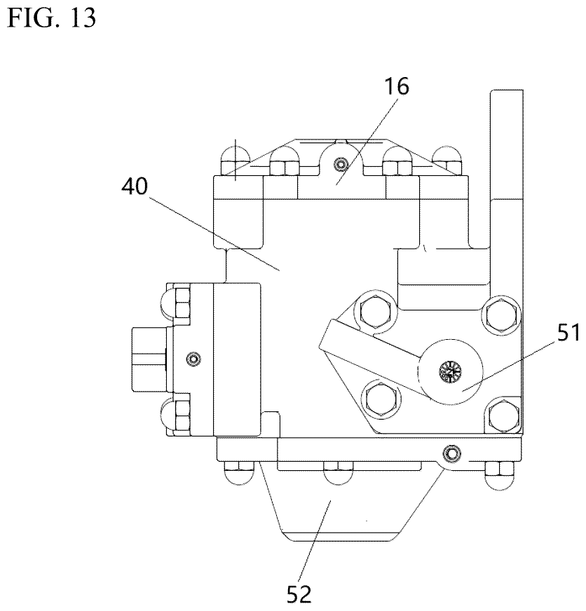

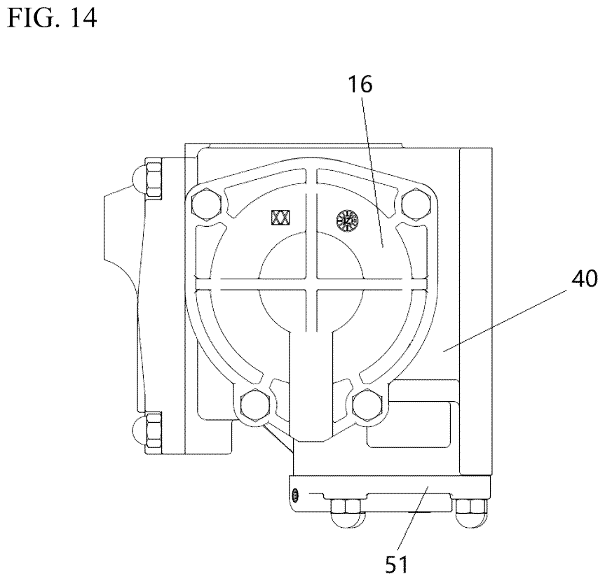

As shown in FIGS. 1-18, an embodiment of the present disclosure provides an air control valve. The air control valve includes a main valve body 10, a sliding valve 20 and a shut-off valve 30, the main valve body 10 is provided with a main valve cavity 11, an air inlet channel 12 and an air exhaust channel 13, the main valve cavity 11 communicates with an auxiliary air cylinder 100, an air inlet 121 of the air inlet channel 12 communicates with a train pipe 110, an air outlet 122 of the air inlet channel 12 communicates with the main valve cavity 11, an air inlet 131 of the air exhaust channel 13 communicates with the main valve cavity 11, the sliding valve 20 is movably disposed in the main valve cavity 11, a side of the sliding valve 20 attaches to a cavity wall of the main valve cavity 11, the sliding valve 20 is provided with a communicating channel 21 and a brake inflation channel 22 in a penetrating manner, an air inlet of the communicating channel 21 correspondingly communicates with the air outlet 122 of the air inlet channel 12, an air outlet of the communicating channel 21 correspondingly communicates with the air inlet 131 of the air exhaust channel 13, an air inlet 221 of the brake inflation channel 22 correspondingly communicates with the main valve cavity 11, an air outlet 222 of the brake inflation channel 22 correspondingly communicates with a brake cylinder 120, the shut-off valve 30 includes a shut-off valve body 31 and a shut-off valve core 32, the shut-off valve body 31 is provided with a shut-off valve cavity 311, the shut-off valve cavity 311 includes a driving cavity 312 and an air exhaust cavity 313 which are not communicated, the shut-off valve core 32 is movably disposed in the driving cavity 312 and separates the driving cavity into an auxiliary air cavity 3121 and a brake cavity 3122, the auxiliary air cavity 3121 communicates with the auxiliary air cylinder 100, the brake cavity 3122 communicates with the brake cylinder 120, an air inlet 3131 of the air exhaust cavity 313 communicates with an air outlet of the air exhaust channel 13, an air outlet 3132 of the air exhaust cavity 313 communicates with an outside, an end of the shut-off valve core 32 extends into the air exhaust cavity 313, and the shut-off valve core 32 has an air outlet position for communicating the air inlet 3131 of the air exhaust cavity 313 with the air outlet 3132 of the air exhaust cavity 313 and a closing position for separating the air inlet 3131 of the air exhaust cavity 313 from the air outlet 3132 of the air exhaust cavity 313.

By adoption of the technical solution of the present disclosure, after the air control valve enters a brake position, pressure air in the train pipe 110 enters the main valve cavity 11 through the air inlet channel 12 and enters the air exhaust channel 13 through the communicating channel 21 of the sliding valve 20, so as to be exhausted from the main valve cavity 11, meanwhile, pressure air in the auxiliary air cylinder 100 enters the brake inflation channel 22 of the sliding valve 20 through the main valve cavity 11 and enters the brake cylinder 120, after entering the brake position, pressure air in the train pipe 110 is capable of being exhausted through the main valve cavity 11, meanwhile, pressure air in the auxiliary air cylinder 100 is inflated into the brake cylinder 120, therefore, in addition to decompression of the train pipe 110, pressure air in the train pipe 110 is capable of being further exhausted through the main valve cavity 11, so that the air exhaust speed of the train pipe 110 is accelerated, and the train rapidly enters a braking state. Meanwhile, as the air exhaust speed of the train pipe 110 is accelerated, the transmission speed of braking action is improved, the synchronization of braking of the train is improved, and the longitudinal impact force among vehicles in the train is reduced, so as to reduce the braking distance.

A side of the sliding valve 20 attaches to the cavity wall of the main valve cavity 11, so that the communication of the air outlet 122 of the air inlet channel 12 and the main valve cavity 11 is blocked, and the air outlet 122 of the air inlet channel 12 can communicate with the main valve cavity 11 only through the channel of the sliding valve 20.

In the embodiment, a piston assembly 60 is disposed in the main valve cavity 11, the piston assembly 60 is driven to move through pressure difference, as the movement of the piston assembly 60 drives the sliding valve 20 to move, so that the channel of the sliding valve 20 communicates different channels of the main valve body 10, and the train is capable of being in a braking state or relieving state. However, after the train enters the braking state, the train pipe 110 is capable of being further drained through the communicating channel 21, if control is not carried out, the decompression amount of the train pipe 110 may exceed the maximum effective decompression amount, namely, when the pressure of the train pipe 110 is reduced from a full state to lower the a pressure that the auxiliary air cylinder 100 and the brake cylinder 120 are in complete balance, then the piston assembly 60 cannot move to a position that the train enters a brake pressure maintaining position, meanwhile, if the train pipe 110 is drained all the time, the locomotive may supplement air for leakage of the train pipe, then accidental relieving may occur due to increase of pressure of the train pipe 110, therefore, the shut-off valve 30 communicating the air outlet of the air exhaust channel 13 needs to be disposed for solving the problem of constant air exhaust of the train pipe 110 under an excessive decompression condition.

It is to be noted that with movement of the piston assembly 60, the communicating channel 21 in the sliding valve 20 communicates with the air outlet 122 of the air inlet channel 12, meanwhile, the air outlet of the communicating channel 21 communicates with the air inlet 131 of the air exhaust channel 13, so that air of the train pipe 110 is capable of being exhausted through the main valve cavity 11, meanwhile, pressure air in the auxiliary air cylinder 100 is capable of passing through the main valve cavity 11 and being inflated into the brake cylinder 120 through the brake inflation channel 22, so that the train enters the braking state.

Pressure air in the brake cylinder 120 is inflated from that in the auxiliary air cylinder 100, so that the maximum pressure of the brake cylinder 120 may not exceed the pressure of the auxiliary air cylinder 100, meanwhile, the auxiliary air cavity 3121 communicates with the auxiliary air cylinder 100, and the brake cavity 3122 communicates with the brake cylinder 120. Therefore, under any working condition, the pressure in the auxiliary air cavity 3121 is high all the time, when the auxiliary air cylinder 100 starts to inflate pressure air to the brake cylinder 120, the shut-off valve 30 is under the action of driving pressure difference, the shut-off valve core 32 is located at the air outlet position communicating the air inlet 3131 of the air exhaust cavity 313 and the air outlet 3132 of the air exhaust cavity 313, so that the train pipe 110 is capable of being further drained. However, when the decompression amount of the train pipe 110 achieves or exceeds the maximum effective decompression amount, pressure in the brake cylinder 120 and that in the auxiliary air cylinder 100 are equal, the shut-off valve core 32 resets to the closing position blocking the air inlet 3131 of the air exhaust cavity 313 and the air outlet 3132 of the air exhaust cavity 313, so that the train pipe 110 is not allowed to be drained continuously, and the accidental condition is avoided.

In the embodiment, the shut-off valve core 32 includes a driving valve core and an air inflation valve core, the driving valve core separates the driving cavity 312 into the auxiliary air cavity 3121 and the brake cavity 3122, the driving valve core is capable of driving the air inflation valve core to move, so that the air inflation valve core has the air outlet position communicating the air inlet 3131 of the air exhaust cavity 313 and the air outlet 3132 of the air exhaust cavity 313 and the closing position blocking the air inlet 3131 of the air exhaust cavity 313 and the air outlet 3132 of the air exhaust cavity 313.

Specifically, a first valve sleeve is disposed in the shut-off valve cavity 311, an outer side wall of the first valve sleeve attaches to a cavity wall of the shut-off valve cavity 311 and separates the shut-off valve cavity 311 into the driving cavity and the air exhaust cavity 313, and one end of the driving valve core is movably disposed on the first valve sleeve in a penetrating manner.

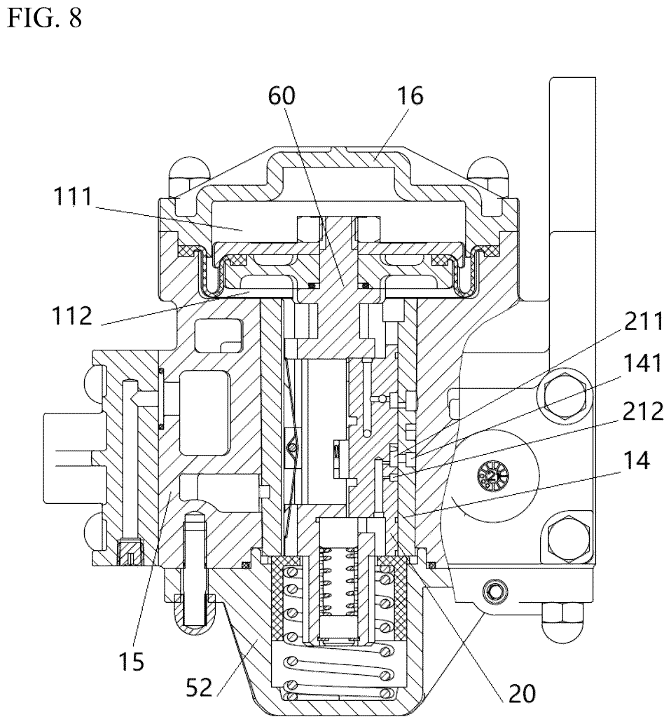

As shown in FIGS. 8-10, the communicating channel 21 includes a first communicating channel 211 and a second communicating channel 212 which are communicated, the second communicating channel 212 is located below the first communicating channel 211, an air inlet of the first communicating channel 211 correspondingly communicates with the air outlet 122 of the air inlet channel 12, and an air outlet 2112 of the first communicating channel 211 and an air outlet 2121 of the second communicating channel 212 correspondingly communicate with the air inlet 131 of the air exhaust channel 13. With the communicating channel 21 adopting the above structure, the communicating of the air inlet channel 12 and the air exhaust channel 13 is realized by utilizing the first communicating channel 211, so that the train pipe 110 starts to be drained, the train enters a local decompression state, preparation is made for brake of the train, therefore, the train is capable of rapidly entering the braking state, meanwhile, by utilizing the second communicating channel 212, after the train enters the braking state, the communicating of the air inlet channel 12 and the air exhaust channel 13 is still realized through the second communicating channel 212, so that the train pipe 110 is continuously drained, and braking of the train is accelerated.

It is to be noted that by disposing the communicating channel 21 as the first communicating channel 211 and the second communicating channel 212 communicating with each other, the area of the air outlet of the communicating channel 21 is reduced, then excessive high drain speed of the train pipe 110 is avoided, and therefore, maloperation of an emergency valve of the train during normal braking is avoided.

In the embodiment, after the train enters the braking state, the pressure air in the train pipe 110 still is reliably exhausted through the second communicating channel 212, so that the effect of improving the transmission speed of the braking action of the train is achieved, vehicles of the train enter the braking state more synchronously, the longitudinal impact force when each vehicles in the train brake is reduced, and the braking distance of the train is shortened.

The main valve body 10 and the shut-off valve body 31 are integrally formed, the main valve body 10 and the shut-off valve body 31 form a control valve body 40 together, and the shut-off valve cavity 311 and the main valve cavity 11 are disposed at an interval. With the control valve body 40 adopting the above structure, after the train enters the braking state, pressure air of the train pipe 110 is exhausted still through the control valve body 40, meanwhile, that the decompression amount of the train pipe 110 achieves or exceeds the maximum effective decompression amount is avoided through the shut-off valve 30, so that the accidental working condition of the train is avoided.

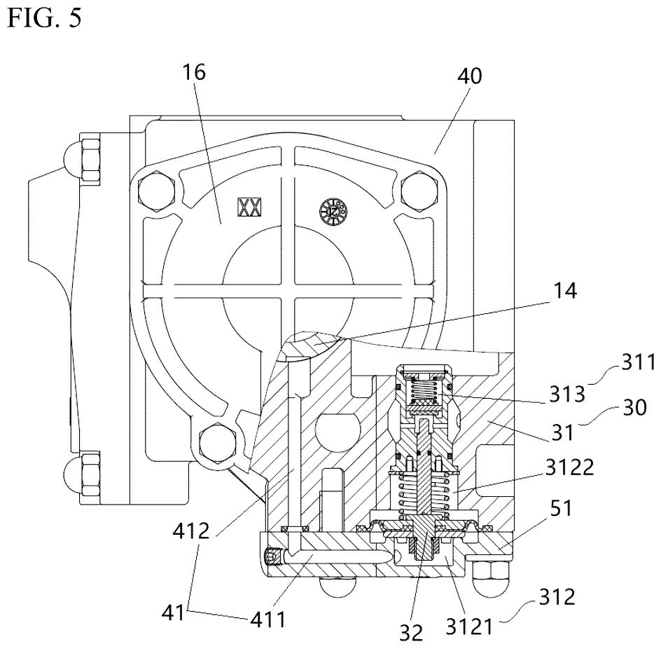

As shown in FIG. 5, the control valve body 40 is provided with an auxiliary air channel 41, the main valve cavity 11 communicates with the auxiliary air cylinder 100, an end of the auxiliary air channel 41 communicates with the main valve cavity 11, and another end of the auxiliary air channel 41 communicates with the auxiliary air cavity 3121. With the auxiliary air channel 41, the communicating of the auxiliary air cavity 3121 and the auxiliary air cylinder 100 is realized through the main valve cavity 11, so that communication is realized, and miniaturization of the control valve body 40 is realized.

As shown in FIGS. 5, 13 and 14, the air control valve further includes a shut-off valve cover 51, the shut-off valve cover 51 is located on a side of the control valve body 40 and covers the shut-off valve body 31, the auxiliary air channel 41 includes a first section 411 and a second section 412 which are communicated, the first section 411 is disposed on the shut-off valve cover 51, and the second section 412 is disposed on the main valve body 10. With the shut-off valve cover 51 adopting the above structure, the shut-off valve body 31 is sealed and covered by utilizing the shut-off valve cover 51, meanwhile, the first section 411 is disposed by utilizing the shut-off valve cover 51, so that the miniaturization of the control valve body 40 is facilitated.

Specifically, the driving valve core includes a valve rod and a valve cap which are connected, the extending directions of the valve rod and the valve cap are vertical, one end of the valve rod is disposed corresponding to the air inflation valve core, and then the air inflation valve core is capable of moving. The valve cap includes a first annular plate, a second annular plate and an elastic sheet, the inner ring of the elastic sheet is clamped between the first annular plate and the second annular plate, and the outer ring of the elastic sheet is clamped between the shut-off valve body 31 and the shut-off valve cover 51, so that the driving cavity 312 is separated into the auxiliary air cavity 3121 and the brake cavity 3122.

Meanwhile, an annular bulge is disposed on the periphery of the valve rod, the driving valve core further includes a locking nut connected with the valve rod, the valve cap is clamped between the annular bulge and the locking nut, the first annular plate is abutted to the locking nut, and the second annular plate is abutted to the annular bulge.

Specifically, a second valve sleeve is further disposed in the shut-off valve cavity 311, the second valve sleeve is located on a side, away from the shut-off valve cover 51, of the first valve sleeve, the outer side wall of the second valve sleeve attaches to the cavity wall of the shut-off valve cavity 311, the air outlet end of the second valve sleeve is the air outlet 3132 of the air exhaust cavity 313, the air inlet end of the second valve sleeve communicates with the air inlet 3131 of the air exhaust cavity 313, and the driving valve core movably penetrates through the first valve sleeve and is disposed on the second valve sleeve in a penetrating manner, so that the driving valve core is capable of driving the air inflation valve core to communicate the air outlet end of the second valve sleeve and the air inlet 3131 of the air exhaust cavity 313 and release the air inflation valve core.

In the embodiment, the first valve sleeve and the second valve sleeve are integrally formed, the first valve sleeve and the second valve sleeve form a guide sleeve together, an air inflation hole disposed in a penetrating manner is formed on the side wall of the guide sleeve, and two ends of the air inflation hole respectively communicate with the air outlet end of the second valve sleeve and the outside.

It is to be noted that the air inflation valve core includes an air vent plate and an elastic cap sleeving the air vent plate, a plurality of bulges are disposed on the periphery of the air vent plate, the plurality of bulges are disposed along the circumferential direction of the air vent plate at intervals and extend along the radial direction of the air vent plate, and the elastic cap and the air outlet end of the second valve sleeve are in sealed cooperation.

Meanwhile, a first reset spring and a support plate are disposed in the second valve sleeve, the support plate is disposed on the side, away from the driving valve core, of the air inflation valve core, the outer edge of the support plate is connected with the inner side wall of the second valve sleeve, two ends of the first reset spring are abutted to the air inflation valve core and the support plate respectively, and an air vent hole is disposed on the support plate.

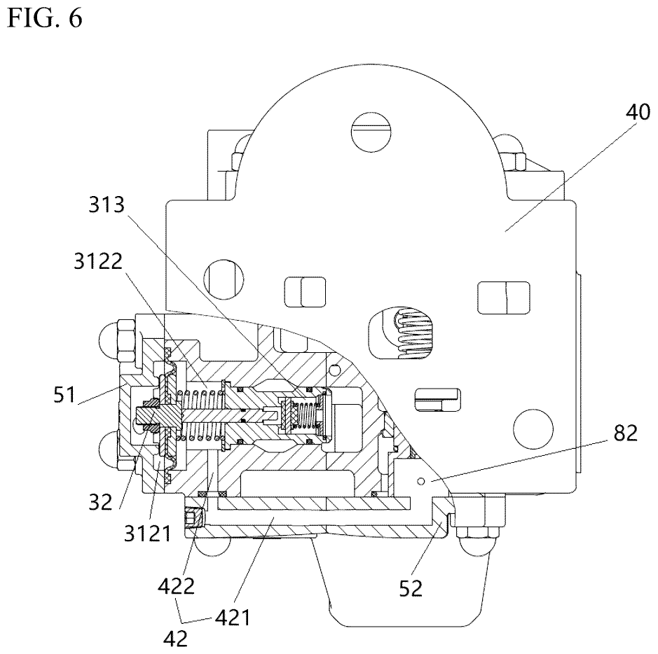

As shown in FIG. 6, the control valve body 40 is provided with a brake channel 42, and one end of the brake channel 42 communicates with the brake cavity 3122, and another end of the brake channel 42 communicates with the brake cylinder 120. With the adoption of the brake channel 42, the communicating of the brake cavity 3122 and the brake cylinder 120 is facilitated, and miniaturization of the control valve body 40 is facilitated.

As shown in FIGS. 6 and 8, the air control valve further includes a first valve cover 52, the first valve cover 52 is located at a lower end of the control valve body 40 and covers the main valve body 10, the brake channel 42 includes a third section 421 and a fourth section 422 which are communicated, the third section 421 is disposed on the first valve cover 52, and the fourth section 422 is disposed on the shut-off valve body 31. With the first valve cover 52 adopting the above structure, the main valve body 10 is sealed and covered by utilizing the first valve cover 52, meanwhile, the third section 421 is disposed by utilizing the first valve cover 52, so that the miniaturization of the control valve body 40 is facilitated.

As shown in FIG. 8, the air control valve further includes the piston assembly 60 movably disposed in the main valve cavity 11, the piston assembly 60 separates the main valve cavity 11 into a first main valve cavity 111 and a second main valve cavity 112, the first main valve cavity 111 communicates with the train pipe 110, the air inlet channel 12 and the air exhaust channel 13 both communicate with the second main valve cavity 112, the piston assembly 60 is provided with a first groove 61 extending in a same direction as the main valve cavity 11, the side of the sliding valve 20 attaches to the cavity wall of the main valve cavity 11, and another side of the sliding valve 20 is embedded in the first groove 61. The sliding valve 20 is driven to move through the piston assembly 60, so that the sliding valve 20 is capable of communicating with a corresponding channel on the main valve body 10, and therefore, the train is switched between a braking working condition and a relieving working condition according to requirements.

It is to be noted that the piston assembly 60 includes a piston rod and an elastic film, the extending directions of the piston rod and the elastic film are vertical, the main valve cavity 11 is separated into the first main valve cavity 111 and the second main valve cavity 112 by utilizing the elastic film, and meanwhile, the movement of the piston rod may not be influenced.

Specifically, by adoption of the manner that the side of the sliding valve 20 attaches to the cavity wall of the main valve cavity 11, the channel on the sliding valve 20 is capable of being isolated from a duct on the main valve body 10, and meanwhile, when the sliding valve 20 is driven to move by the piston assembly 60, the required channel on the sliding valve 20 communicates with the duct on the main valve body 10.

In the embodiment, the height size of the first groove 61 is greater than that of the sliding valve 20, so that the piston assembly 60 has buffer space with the sliding valve 20 in the moving process.

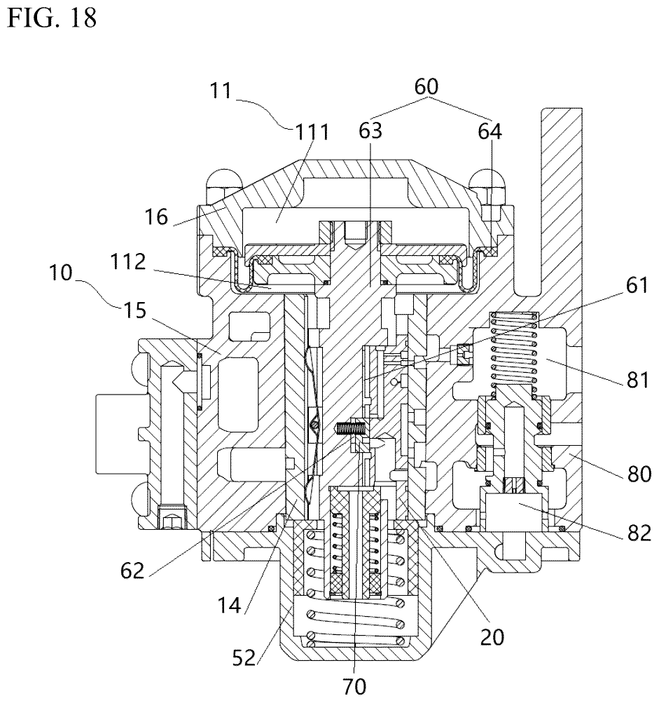

As shown in FIGS. 8 and 18, a sliding valve sleeve 14 is disposed in the main valve body 10, an outer side wall of the sliding valve sleeve 14 attaches to the cavity wall of the main valve cavity 11, the side of the sliding valve 20 attaches to an inner side wall of the sliding valve sleeve 14, the sliding valve sleeve 14 has an air exhaust hole 141, a train inflation hole 142, a brake inflation hole 143 and a communicating hole 144 disposed at intervals, the air outlet of the communicating channel 21 communicates with one end of the air exhaust hole 141, the air inlet 131 of the air exhaust channel 13 communicates with another end of the air exhaust hole 141, two ends of the train inflation hole 142 respectively communicate with the air inlet 121 of the air inlet channel 12 and the air inlet of the communicating channel 21, two ends of the brake inflation hole 143 respectively communicate with the air outlet 222 of the brake inflation channel 22 and the brake cylinder 120, and two ends of the communicating hole 144 respectively communicate with the auxiliary air cavity 3121 and the main valve cavity 11. With the sliding valve sleeve 14 adopting the above structure, a guide effect is formed on the sliding valve 20 by utilizing the sliding valve sleeve 14, and meanwhile, the duct on the sliding valve sleeve 14 communicates with the corresponding channel on the sliding valve 20, so that relieving or brake of the train is realized.

Through the air exhaust hole 141 and the train inflation hole 142, when the train enters braking, pressure air in the train pipe 110 is exhausted out of the control valve body 40 through the air inlet channel 12, the train inflation hole 142, the communicating channel 21, the air exhaust hole 141 and the air exhaust channel 13 in sequence, so that the train rapidly enters the braking state. Through the brake inflation hole 143, when the train enters braking, pressure air in the auxiliary air cylinder 100 is inflated to the brake cylinder 120 through the second main valve cavity 112, the brake inflation channel 22, the brake inflation hole 143 and the brake channel 42 in sequence, the brake cylinder 120 outputs brake force to drive a lever to act, the lever drives a brake to clamp a wheel, and thus the brake function is realized. Through the communicating hole 144, when the train enters braking, pressure air in the auxiliary air cylinder 100 is inflated to the auxiliary air cavity 3121 through the second main valve cavity 112, the communicating hole 144 and the auxiliary air channel 41.

As shown in FIG. 18, the air control valve further includes a graduating valve 70, a second groove 62 is disposed on a side wall of the first groove 61, one side of the graduating valve 70 is embedded in the second groove 62, another side of the graduating valve 70 attaches to a side wall of the sliding valve 20, a communicating groove 71 is disposed on a side, facing the sliding valve 20, of the graduating valve 70, the communicating channel 21 includes an air inlet section 213 and an air exhaust section 214 which are disposed at an interval, and the communicating groove 71 correspondingly communicates the air inlet section 213 with the air exhaust section 214. By adoption of the graduating valve 70, the air inlet section 213 and the air exhaust section 214 of the communicating channel 21 is communicated, so that the pressure air in the train pipe 110 is capable of being drained.

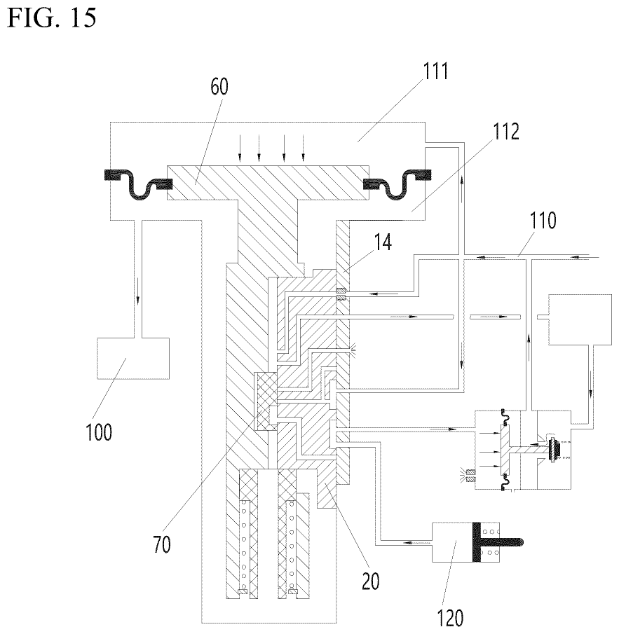

In the embodiment, as shown in FIG. 15, when the train is in an inflation relieving state, the locomotive inflates the air control valve through the train pipe 110, the train pipe 110 inflates the first main valve cavity 111, so that the air pressure in the first main valve cavity 111 is greater than that in the second main valve cavity 112, then the piston assembly 60 moves downwards under the effect of driving pressure difference, meanwhile, the piston assembly 60 drives the sliding valve 20 and the graduating valve 70 to move downwards together, so that the sliding valve 20 and the graduating valve 70 are located at the lowest end, the sliding valve 20 communicates with the train pipe 110 to inflate the second main valve cavity 112, meanwhile, the second main valve cavity 112 inflates the auxiliary air cylinder 100 till a specified pressure, namely, authorised pressure 500 kpa, meanwhile, the air exhaust passage of the brake cylinder 120 is communicated, the pressure air in the brake cylinder 120 is exhausted to the atmosphere, a compression spring is disposed below the piston assembly 60, and in such a case, the compression spring is in a compression state.

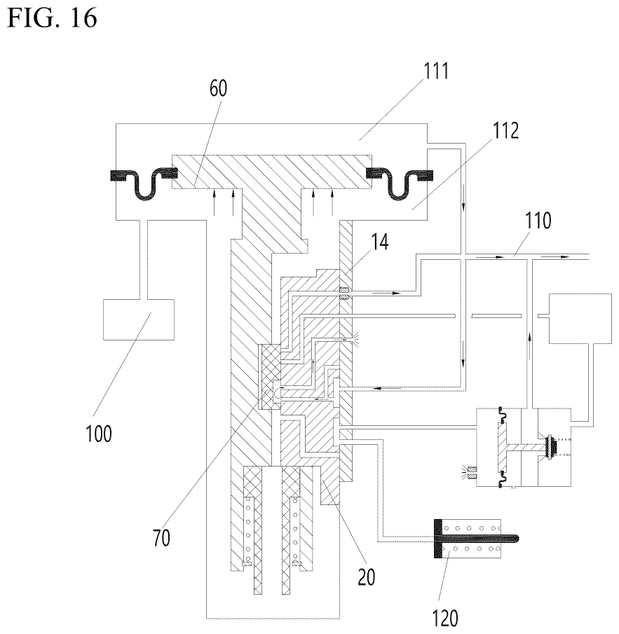

As shown in FIG. 16, when the train is about to brake, the train pipe 110 starts to decompress, as a plug is disposed on a passage through which the train pipe 110 inflates the second main valve cavity 112, the air pressure in the second main valve cavity 112 is greater than that in the first main valve cavity 111, the piston assembly 60 moves upwards through the elastic action of the compression spring below, and drives the graduating valve 70 to move upwards, and in such a case, the air inflation passage between the train pipe 110 and the auxiliary air cylinder 100 is blocked. Pressure air in the train pipe 110 is exhausted out of the control valve body 40 through the air inlet channel 12, the train inflation hole 142, the first communicating channel 211, the air exhaust hole 141 and the air exhaust channel 13 in sequence, the train is in a local decompression state, the air exhaust speed of the train pipe 110 of the whole train is accelerated, so that the air control valve of each train more rapidly enters a braking position, meanwhile, the synchronization that the vehicles in the train enter the braking state is improved, and the longitudinal impact force when the vehicles in the train brake is reduced.

As shown in FIG. 1, the train pipe 110 continuous to decompress, the air pressure in the first main valve cavity 111 is still greater than that in the second main valve cavity 112, the piston assembly 60 drives the sliding valve 20 to move upwards while moving upwards, in such a case, the sliding valve 20 and the graduating valve 70 are both located the uppermost end, meanwhile, pressure air in the train pipe 110 is exhausted out of the control valve body 40 through the air inlet channel 12, the train inflation hole 142, the second communicating channel 212, the air exhaust hole 141 and the air exhaust channel 13 in sequence, meanwhile, pressure air of the auxiliary air cylinder 100 is inflated to the brake cylinder 120 through the second main valve cavity 112, the brake inflation channel 22, the brake inflation hole 143 and the brake channel 42 in sequence, so that the train is in a braking state.

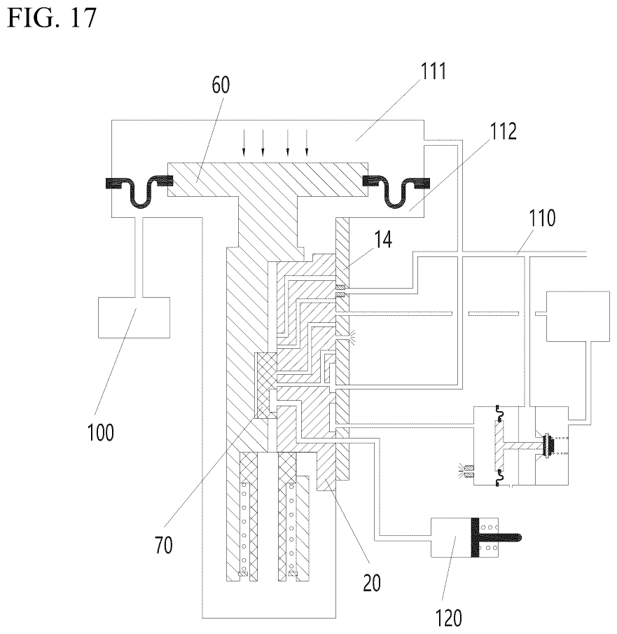

As shown in FIG. 17, when the train pipe 110 is decompressed to the authorised pressure and the decompression is stopped, as the auxiliary air cylinder 100 still inflates the brake cylinder 120, the pressure of the auxiliary air cylinder 100 continues to decrease till the pressure in the first main valve cavity 111 is slightly higher than that in the second main valve cavity 112, the piston assembly 60 drives the graduating valve to move downwards for cutting off an inflation passage of the auxiliary air cylinder 100 and the brake cylinder 120, and the air control valve is at a brake pressure maintaining position.

As shown in FIGS. 8 and 18, the main valve body 10 includes a main body 15 and a second valve cover 16 covering the main body 15, the piston assembly 60 includes a piston body 63 and an elastic film 64 connected with the piston body 63, a periphery of the elastic film 64 is clamped between the main body 15 and the second valve cover 16, a space between the elastic film 64 and the second valve cover 16 forms the first main valve cavity 111, and a space between the elastic film 64 and the main valve body 10 forms the second main valve cavity 112. With the main valve body 10 adopting the above structure, the main valve cavity 11 is separated by the elastic film 64, and the advantage of simple structure is achieved.

In the embodiment, the lower end of the piston assembly 60 extends into the first valve cover 52, and the advantages of compact structure and miniaturization are realized.

As shown in FIG. 18, the air control valve further includes an emergency air inflation valve 80 spaced apart from the main valve body 10, the emergency air inflation valve 80 and the main valve body 10 are integrally formed, the emergency air inflation valve 80 includes an air inflation cavity 81 and a communicating cavity 82 disposed at an interval, an air inlet of the air inflation cavity 81 communicates with the train pipe 110, an air outlet 812 of the air inflation cavity 81 communicates with the air inlet 121 of the air inlet channel 12, an air inlet of the communicating cavity 82 communicates with the air inlet 221 of the brake inflation channel 22, a first air outlet of the communicating cavity 82 communicates with the brake cylinder 120, and a second air outlet of the communicating cavity 82 communicates with the another end of the brake channel 42. With the air control valve adopting the above structure, the emergency air inflation valve 80, the main valve body 10 and the shut-off valve 30 are integrated, and the advantage of multiple functions is achieved.

1. An air control valve, comprising:
a main valve body, provided with a main valve cavity, an air inlet channel and an air exhaust channel, the main valve cavity communicates with an auxiliary air cylinder, an air inlet of the air inlet channel communicates with a train pipe, an air outlet of the air inlet channel communicates with the main valve cavity, and an air inlet of the air exhaust channel communicates with the main valve cavity;
a sliding valve, which is movably disposed in the main valve cavity, a side of the sliding valve attaches to a cavity wall of the main valve cavity, the sliding valve is provided with a communicating channel and a brake inflation channel in a penetrating manner, an air inlet of the communicating channel correspondingly communicates with the air outlet of the air inlet channel, an air outlet of the communicating channel correspondingly communicates with the air inlet of the air exhaust channel, an air inlet of the brake inflation channel correspondingly communicates with the main valve cavity, and an air outlet of the brake inflation channel correspondingly communicates with a brake cylinder;
a shut-off valve, which comprises a shut-off valve body and a shut-off valve core, the shut-off valve body is provided with a shut-off valve cavity, the shut-off valve cavity comprises a driving cavity and an air exhaust cavity which are not communicated, the shut-off valve core is movably disposed in the driving cavity and separates the driving cavity into an auxiliary air cavity and a brake cavity, the auxiliary air cavity communicates with the auxiliary air cylinder, the brake cavity communicates with the brake cylinder, an air inlet of the air exhaust cavity communicates with an air outlet of the air exhaust channel, an air outlet of the air exhaust cavity communicates with an outside, an end of the shut-off valve core extends into the air exhaust cavity, and the shut-off valve core has an air outlet position for communicating the air inlet of the air exhaust cavity with the air outlet of the air exhaust cavity and a closing position for separating the air inlet of the air exhaust cavity from the air outlet of the air exhaust cavity.

2. The air control valve according to claim 1, wherein the communicating channel comprises a first communicating channel and a second communicating channel which are communicated, the second communicating channel is located below the first communicating channel, an air inlet of the first communicating channel correspondingly communicates with the air outlet of the air inlet channel, and an air outlet of the first communicating channel and an air outlet of the second communicating channel correspondingly communicate with the air inlet of the air exhaust channel.

3. The air control valve according to claim 1, wherein the main valve body and the shut-off valve body are integrally formed, the main valve body and the shut-off valve body form a control valve body together, and the shut-off valve cavity and the main valve cavity are disposed at an interval.

4. The air control valve according to claim 3, wherein the control valve body is provided with an auxiliary air channel, one end of the auxiliary air channel communicates with the main valve cavity, and another end of the auxiliary air channel communicates with the auxiliary air cavity.

5. The air control valve according to claim 4, wherein the air control valve further comprises a shut-off valve cover, the shut-off valve cover is located on a side of the control valve body and covers the shut-off valve body, the auxiliary air channel comprises a first section and a second section which are communicated, the first section is disposed on the shut-off valve cover, and the second section is disposed on the main valve body.

6. The air control valve according to claim 3, wherein the control valve body is provided with a brake channel, and one end of the brake channel communicates with the brake cavity, and another end of the brake channel communicates with the brake cylinder.

7. The air control valve according to claim 6, wherein the air control valve further comprises a first valve cover, the first valve cover is located at a lower end of the control valve body and covers the main valve body, the brake channel comprises a third section and a fourth section which are communicated, the third section is disposed on the first valve cover, and the fourth section is disposed on the shut-off valve body.

8. The air control valve according to claim 1, wherein the air control valve further comprises a piston assembly movably disposed in the main valve cavity, the piston assembly separates the main valve cavity into a first main valve cavity and a second main valve cavity, the first main valve cavity communicates with the train pipe, the air inlet channel and the air exhaust channel both communicate with the second main valve cavity, the piston assembly is provided with a first groove extending in a same direction as the main valve cavity, the side of the sliding valve attaches to the cavity wall of the main valve cavity, and another side of the sliding valve is embedded in the first groove.

9. The air control valve according to claim 8, wherein a sliding valve sleeve is disposed in the main valve body, an outer side wall of the sliding valve sleeve attaches to the cavity wall of the main valve cavity, a the side of the sliding valve attaches to an inner side wall of the sliding valve sleeve, the sliding valve sleeve has an air exhaust hole, a train inflation hole, a brake inflation hole and a communicating hole disposed at intervals, the air outlet of the communicating channel communicates with one end of the air exhaust hole, the air inlet of the air exhaust channel communicates with another end of the air exhaust hole, two ends of the train inflation hole respectively communicate with the air inlet of the air inlet channel and the air inlet of the communicating channel, two ends of the brake inflation hole respectively communicate with the air outlet of the brake inflation channel and the brake cylinder, and two ends of the communicating hole respectively communicate with the auxiliary air cavity and the main valve cavity.

10. The air control valve according to claim 9, wherein the air control valve further comprises a graduating valve, a second groove is disposed on a side wall of the first groove, one side of the graduating valve is embedded in the second groove, another side of the graduating valve attaches to a side wall of the sliding valve, a communicating groove is disposed on a side, facing the sliding valve, of the graduating valve, the communicating channel comprises an air inlet section and an air exhaust section which are disposed at an interval, and the communicating groove correspondingly communicates the air inlet section with the air exhaust section.

11. The air control valve according to claim 8, wherein the main valve body comprise a main body and a second valve cover covering the main body, the piston assembly comprises a piston body and an elastic film connected with the piston body, a periphery of the elastic film is clamped between the main body and the second valve cover, a space between the elastic film and the second valve cover forms the first main valve cavity, and a space between the elastic film and the main valve body forms the second main valve cavity.

12. The air control valve according to claim 6, wherein the air control valve further comprises an emergency air inflation valve spaced apart from the main valve body, the emergency air inflation valve and the main valve body are integrally formed, the emergency air inflation valve comprises an air inflation cavity and a communicating cavity disposed at an interval, an air inlet of the air inflation cavity communicates with the train pipe, an air outlet of the air inflation cavity communicates with the air inlet of the air inlet channel, an air inlet of the communicating cavity communicates with the air inlet of the brake inflation channel, a first air outlet of the communicating cavity communicates with the brake cylinder, and a second air outlet of the communicating cavity communicates with the another end of the brake channel.
